(19) United States
(12) Patent Application Publication
(10) Pub. No.: US 2007/0100720 A1
(43) Pub. Date: May 3, 2007

(54) Annuity having an enhanced rate of return based on performance of an index

(75) Inventor: John G. Bonvouloir, Needham, MA (US)

Correspondence Address: FOLEY AND LARDNER LLP;SUITE 500, 3000 K STREET NW, WASHINGTON, DC, 20007, US

(73) Assignee: Aviva Life Insurance Company

(21) Appl. No.: 11/260,633

(22) Filed: Oct. 28, 2005

(51) Int. Cl. G06Q 40/00

(52) U.S. Cl. 705/36 R

(57) ABSTRACT

A computer implemented method of assessing an interest increase in an annuity linked to an index of equities includes determining a change in an equity index over a time period, setting an interest increase in an annuity to a floor if the determined change in the equity index is not greater than the floor, calculating the interest increase in the annuity to be a participation percentage of the determined change in the equity index if the determined change is greater than the floor where the participation percentage of the determined change is calculated up to a threshold change level in the determined change in the equity index, and adding an enhanced interest increase amount to the interest increase in the annuity if the determined change in the equity index is greater than the threshold change level. The enhanced interest increase amount is an enhanced percentage of the determined change in the equity index above the threshold change level.

### BACKGROUND OF THE INVENTION

1. Field of the Invention

The present invention relates to annuities and techniques for structuring rate of returns for annuities. More specifically, the invention relates to a fixed index annuity product having an enhanced rate of return based on performance of an index.

2. Description of the Related Art

An annuity is a series of income payments made at regular intervals by an insurance company in return for a premium or premiums paid. The most frequent use of income payments from an annuity is for retirement. An immediate annuity begins to make income payments soon after the premium is paid. The income payments from a deferred annuity start later, often many years later. Deferred annuities have an accumulation period, which is the time between when premium payments start and when income payments start. The time after income payments start is called the payout period. During the accumulation period of a fixed deferred annuity, premiums (less any applicable charges) earn interest at rate set by the annuity company or in a way spelled out in the annuity contract. During the payout phase, the amount of each income payment received is generally set when the payment start and does not change.

A fixed index annuity is a fixed annuity, either immediate or deferred, that earns interest or provides benefits that are linked to an external equity reference or an equity index. The value of the index might be tied to a stock or other equity index. One of the most commonly used indices is Standard & Poor's 500 Composite Stock Price Index (the “S&P 500”), which is an equity index. The value of any index varies from day-to-day and is not predictable.

A fixed index annuity is different from other fixed annuities because of the way it credits interest to the annuities value. Some fixed annuities only credit interest calculated at a rate set in the contract. Other fixed annuities credit interest at a rate set from time to time by the insurance or annuity company. Fixed index annuities credit interest using a formula based on changes in the index to which the annuity is linked. The formula decides how the additional interest, if any, is calculated and credited. How much additional interest is obtained and when it is obtained depends on the features of the particular annuity. Typically, fixed index annuities, like other fixed annuities, promise to pay a minimum interest rate. The rate that is applied will not be less than this minimum guaranteed rate even if the index-linked interest rate is lower. Further, typically the value of the annuity will not drop below a guaranteed minimum. For example, many single premium annuity contracts guarantee the minimum value to never be less than 90% of the premium paid, plus at least 3% in annual interest (less any partial withdrawals). A guaranteed value is the minimum amount available during a term for withdrawals as well as for some annuitizations and death benefits. The annuity company adjusts the value of the annuity at the end of each term to reflect any index increases.

Two features that have an effect on the amount of additional interest that is credited to a fixed index annuity are the indexing method and the participation rate. The indexing method refers to the approach used to measure the amount of change, if any, in the index. Some of the most common indexing methods include annual reset (ratcheting), high-water mark, and point-to-point indexing. The index term is the period over which index-linked interest is calculated. In many product designs, interest is credited to the annuity at the end of the term. Terms are generally from one to ten years, with six or seven years being most common. Some annuities offer single terms while others offer multiple, consecutive terms. If the annuity is multiple terms, there is usually a window at the end of each term, particularly thirty days, during which money may be withdrawn. For installment premium annuities, the payment of each premium begins a new term for that premium.

The participation rate refers to how much of the increase in the index is used to calculate index-linked interest. For example, if the calculated change in the index is nine percent and the participation rate is seventy percent, the index-linked interest rate will be 6.3% (9%×70%=6.3%). Annuity companies may set different participation rates for newly issued annuities as often as each day. As such, the initial participation rate in the annuity depends on when it is issued by the company. The company offering the annuity usually guarantees the participation rate for a specific period (from one year to the entire term). When the period is over, the company sets a new participation rate for the next period. Some annuities guarantee that the participation rate will never be set lower than a specified minimum or higher than a specified maximum.

Some annuities may put an upper limit, or cap, on the index-linked interest rate. This cap is the maximum rate of interest the annuity will earn. In the example given above where the index-linked interest is 6.3%, if the contract has a 6% cap rate, 6%, and not 6.3%, will be credited. The “floor” is the minimum index-linked interest rate the annuity will earn. The most common floor is 0%. A 0% floor assures that even if the index decreases in value, the index-linked interest that is earned will be zero and not negative. As in the case of a cap, not all annuities have a stated floor on index-linked interest rates.

In the annual reset indexing method, index-linked interest, if any, is determined each year by comparing the index value at the end of the contract year with the index value at the start of contract year. Interest is added to the annuity each year during the term. In the high-water mark indexing method, the index-linked interest, if any, is determined by looking at the index value at various points during the term, usually the annual anniversaries of the date the annuity was purchased. The interest is based on the difference between a highest index value and the index value at the start of the term. Interest is added to the annuity at the end of the term. In point-to-point indexing method, the index-linked interest, if any, is based on the difference between the index value at the end of the term and the index value at the start of the term. Interest is added to the annuity at the end of each term.

Cap annuities can provide for good returns on low and average years for the index. However, a cap annuity limits returns on years where there is a large gain in the index. Therefore, a need exists for an annuity that provides higher returns with greater increases in the index on which the annuity is based.

### SUMMARY OF THE INVENTION

The present invention relates to a fixed index annuity product having a level above which the index-linked interest gets an increased percentage of the index-linked interest. Such an annuity includes an enhanced rate of return based on a performance of the index to which the annuity is linked. If the index incurs a gain over the contract year, interest is credited for a portion of those gains based on a certain pre-determined participation rate up to a pre-determined level. If the index incurs a gain over the contract year that is over and above a set level, then the interest is credited for 100% (or some other set rate) of those gains over that set level. This set level may be known as a breakthrough level.

More specifically, according to one aspect of the invention, a computer implemented method of crediting interest in an indexed annuity includes monitoring performance of an index, such as a Dow Jones, NASDAQ or S&P 500 using an indexing method such as a periodic or reset method. Further, the computer implemented method includes a gain calculation such as a point-to-point, averaging or high-water calculation, which can be monthly, quarterly, or annually. The method includes an adjustment based on a participation rate, a cap, or a spread/margin, depending on the guarantees and the annual reset of the annuity product, and based on the amount of the index gain above a set threshold level. The method includes a credit of the interest compared to a guarantee, where the credit is a percentage of the index gain up to the threshold level and the full index gain above the threshold level.

An exemplary embodiment relates to a computer implemented method of assessing an interest increase in an annuity linked to an index of equities. The computer implemented method includes determining a change in an equity index over a time period, setting an interest increase in an annuity to a floor if the determined change in the equity index is not greater than the floor, calculating the interest increase in the annuity to be a participation percentage of the determined change in the equity index if the determined change is greater than the floor where the participation percentage of the determined change is calculated up to a threshold change level in the determined change in the equity index, and adding an enhanced interest increase amount to the interest increase in the annuity if the determined change in the equity index is greater than the threshold change level. The enhanced interest increase amount is an enhanced percentage of the determined change in the equity index above the threshold change level.

Another exemplary embodiment relates to a fixed index annuity product embodied in a memory of a computer including an index term, a participation rate, and an enhanced rate. The index term is a period over which index-linked interest of an equity index is calculated. The participation rate is a percentage of an index increase of the equity index over the index term used in determining the index-linked interest up to a threshold index increase level. The enhanced rate is a rate of the index increase of the equity index over the index term used in determining the index-linked interest over the threshold index increase level.

Another exemplary embodiment relates to a system for calculating index-linked interest in a fixed index annuity having a breakthrough level above which an enhanced percentage of index gain is provided to the index-linked interest. The system includes means for determining gain in an equity index and means for determining index-linked interest for an equity index annuity that tracks the equity index. The index-linked interest is a percentage of the determined gain up to a threshold plus an enhanced percentage of the determined gain above the threshold.

### BRIEF DESCRIPTION OF DRAWINGS

FIG. 1 is a flow chart illustrating operations performed in managing the annuity contract in accordance with an exemplary embodiment.

FIG. 2 is an exemplary table illustrating rate of return of the annuity contract of FIG. 1 in accordance with an exemplary embodiment.

FIG. 3 is a diagrammatical representation of the annuity contract of FIG. 1 in accordance with an exemplary embodiment.

FIG. 4 is a representation of a platform system including the annuity contract of FIG. 1 in accordance with an exemplary embodiment.

FIG. 5 is a flow chart illustrating operations performed in originating an account and in updating the cap and breakthrough rates in accordance with an exemplary embodiment.

### DETAILED DESCRIPTION OF EXEMPLARY EMBODIMENTS

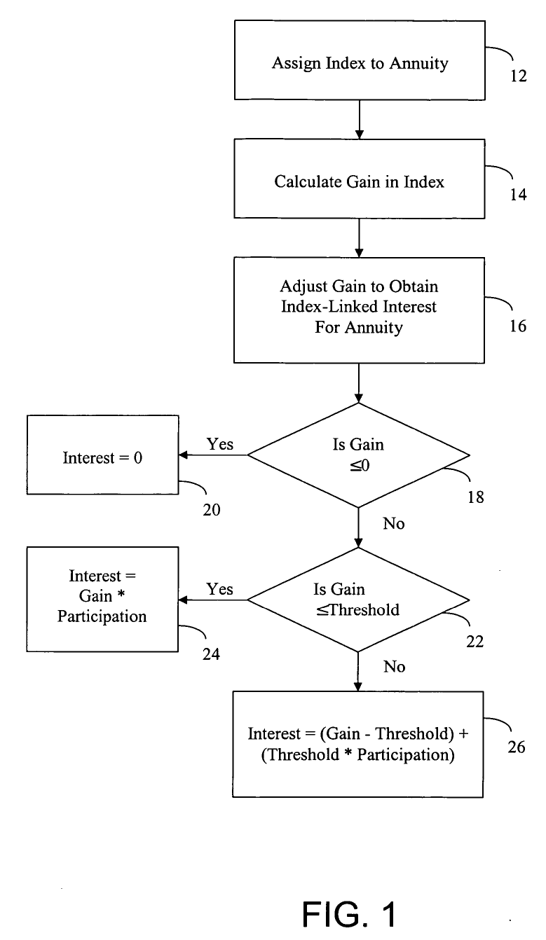

FIG. 1 illustrates operations performed in the management of an annuity having an enhanced rate of return in accordance with an exemplary embodiment. Additional, fewer, or different operations may be performed depending on the embodiment or implementation. In an operation 12, an index is assigned to an annuity. The index might be tied to a stock or an equity index, such as the NASDAQ, Dow Jones or S&P 500 indices. In an operation 14, the gain in the assigned index over a chosen time period is calculated. The gain in the index, or the index-linked interest, may be determined using an annual reset, a high-water mark, a point-to-point index, or some other method. The annual reset method calculates index gain by comparing the index value at the end of the annuity's contract year with the index value at the start of the contract year. The high-water mark method calculates index gain by comparing the index value at the start of the contract year with the highest index value during the contract year. The point-to-point index method calculates index gain based on the difference in index values at the start and at the end of the annuity term (rather than at the beginning and end of a contract year within the annuity term). The gain may be calculated monthly, quarterly, annually, or at some other frequency.

In an operation 16, the gain in the index is adjusted to obtain a return to be paid to the annuity. As part of the adjustment calculation, an operation 18 is performed to determine if the gain is less than or equal to zero or some other minimum index-linked interest rate or floor. If the gain is equal or less to this floor, then operation 20 is performed in which the floor, or in this case zero, is set as the index-linked interest. An operation 22 is performed to determine if the gain is less than or equal to a breakthrough level or pre-determined rate level. If this is the case, an operation 24 is performed in which the rate of return value or the index-linked interest is calculated by multiplying the gain in the index times the participation rate.

If the gain is greater than the breakthrough level or a pre-determined rate level, an operation 26 is performed in which the rate of return or index-linked interest is calculated by adding the rate above the breakthrough level with the product of the participation rate and the breakthrough level. For example, if the breakthrough level is 15% and the participation rate is 25%, and the index return is 20%, the rate of return is (20%−15%)+(15%×25%) to yield a total of 8.8%.

After calculating the index-linked interest, the interest is credited to the annuity. In an exemplary embodiment, the participation rate remains the same throughout the life of the annuity contract while the breakthrough rate is reset annually based on a number of factors, including predicted performance of the index assigned to the annuity.

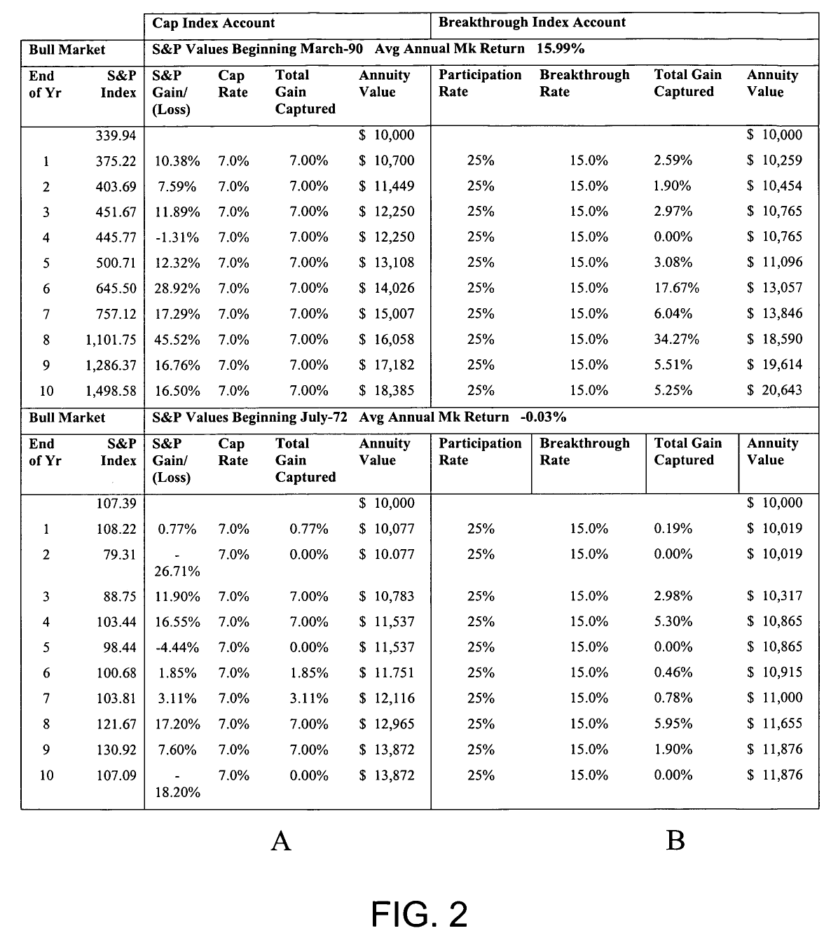

FIG. 2 illustrates a table of crediting mechanics for the method described with respect to FIG. 1 under different market scenarios. The table uses a hypothetical breakthrough rate of 15%, participation rate of 20%, and a $10,000.00 deposit. The top portion of the table of FIG. 2 illustrates a “bull” market where the average annual market return is 15.99%. The lower portion of the table illustrates a “bear” market with an average annual market return of −0.03%. Portion A (on the left) of the table of FIG. 2 illustrates the annuity value over ten years using a cap index account and portion B (on the right) illustrates annuity value over the same ten years utilizing the method described with reference to FIG. 1, which could be referred to as a breakthrough index account. As illustrated in the table of FIG. 2, after ten years, the value of the annuity is greater with the breakthrough index account as compared to the cap account during the bull market, but lower than the cap account during a bear market. Different results are experienced depending on the performance of the index to which the annuity is linked.

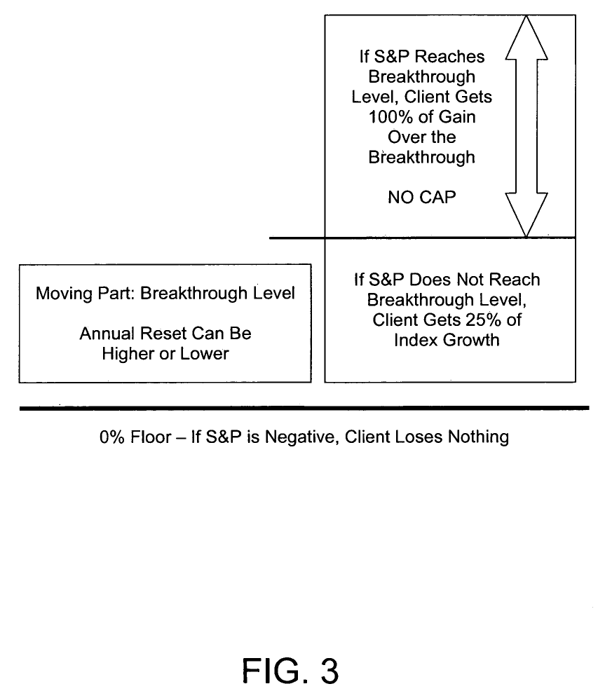

FIG. 3 illustrates graphically the operation of an index annuity utilizing a breakthrough level or enhanced rate of return structure. In the example illustrated, if the index (e.g., the S&P 500) is negative, the owner of the annuity loses nothing because there is a 0% floor. If the index increase does not reach a breakthrough level, the annuity owner gets a participation rate of the index growth. Where the participation rate is 25%, the annuity owner gets 25% of the index increase. For a gain of the index over the breakthrough level, a client gets 100% (or some other set percentage) of the index gain over the breakthrough.

The annuity described with reference to FIGS. 1-3 can be used in combination with other annuity products. In such embodiments, allocations of premiums can be distributed among the different products. For example, the described annuity can be combined with a cap account annuity and the combination can be a “blended account.” The described annuity or the combination annuity with the cap annuity can also be combined with a fixed annuity.

Moreover, the annuity described herein can have a wide range of payout options. For example, the annuity can have income for a fixed period, life only income, life with a guaranteed period, life with an installment refund, interest only, and income of a fixed amount. The annuity described herein benefits from market volatility and annual reset capability. Down years in the index are limited in the penalty to the annuity because of the floor. Moreover, losses do not compound. Each year in the life of the annuity is treated separately such that the annuity holder can take advantage of recovery from market drops. Years in which the index gain is above the threshold or breakthrough level can greatly increase the annuity's effective annual return.

A wide range of variations may be utilized in the annuity described herein. For example, the gain above the threshold or breakthrough level can be the full index gain above the threshold, a percentage of the index gain above the threshold, a percentage multiple of the participation rate, etc. The threshold level can be determined by a variety of different means. In alternative embodiments, there are more than one threshold levels where the enhanced index-linked interest increases with greater threshold levels.

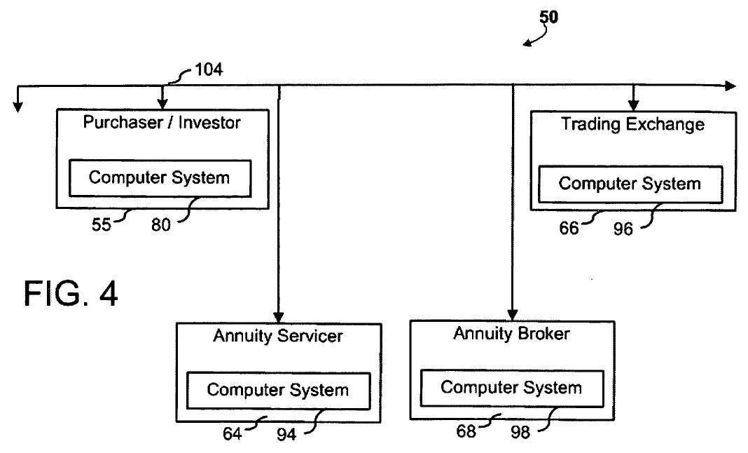

FIG. 4 illustrates a computer system 50 usable to implement various features described herein is shown. The computer system 50 can include a variety of computer subsystems, including a computer system 80 associated with a purchaser 55 of an annuity, a computer system 94 associated with an annuity servicer 64, a computer system 96 associated with a trading exchange 66, and a computer system 98 associated with an annuity broker 68. Each of the computer systems 80-98 may comprise a single computer including a microprocessor and memory with program logic and stored data to implement the features described herein, or may comprise multiple computers which are connected together, for example, by way of a network (not shown). The computer systems 80-98 are coupled by way of a network 104, which is shown to be a single network but which may in practice comprise one or more individual point-to-point connections and/or which may comprise one or more network connections, such as the Internet.

The trading exchange computer system 96 and/or the annuity broker computer system 98 may execute annuity origination and/or annuity calculation software. In one configuration, the software executed by the trading exchange computer system 96 and/or the broker computer system 98 is a web-based interface (e.g., a web browser) 94 100, and the computer system 94 executes the core algorithms that provide the functionality and logic of the origination/calculation software. The calculation and origination software includes computer code that executes instructions to receive information to be used in creation and updating of an annuity, including determining gain in an equity index and determining index-linked interest for a fixed index annuity that tracks the equity index.

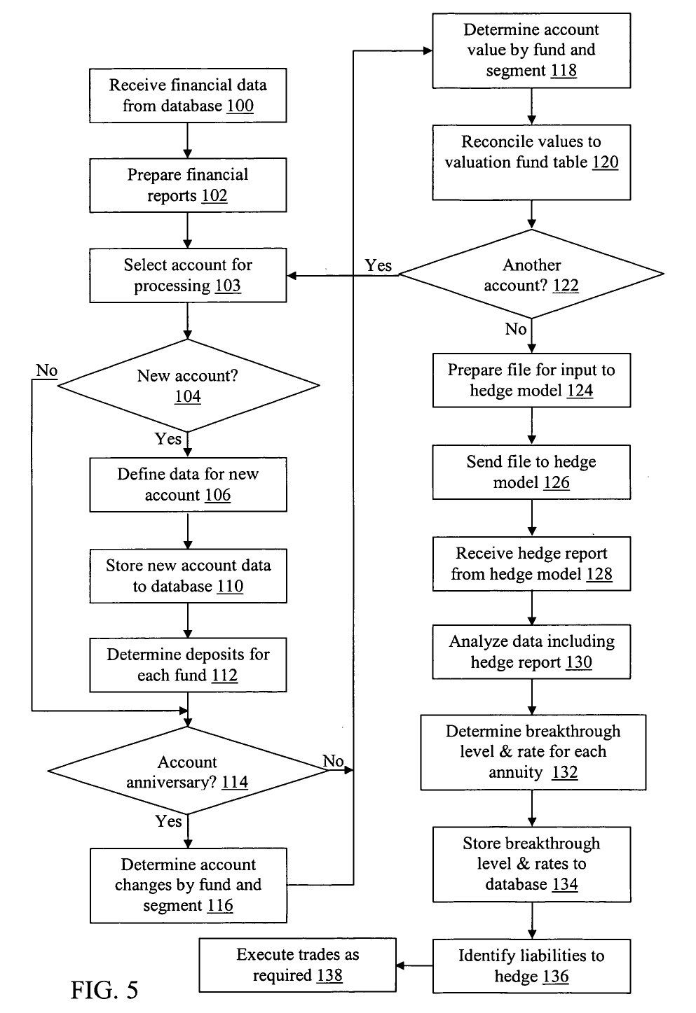

The computer system 50 may be used to electronically carry out the transactions described herein, and to conduct other processing/transactions in connection with the fixed index annuity. FIG. 5 illustrates operations performed in originating an account and updating the breakthrough level and rate in accordance with an exemplary embodiment. Additional, fewer, or different operations may be performed depending on the embodiment or implementation. The operations also may be performed in a different order than that presented. In an operation 100, financial data is received from a database. A number of databases can be provided by commercial and non-commercial entities that include real-time and non-real-time business and financial information associated with companies in a region or worldwide. An exemplary database includes S&P index value data provided on a daily basis. The financial data may be sent from the database automatically or as requested. In an exemplary embodiment, the frequency of receipt of the data is nightly. In an exemplary embodiment, the financial data is received into preset tables. Exemplary tables are associated with fund choice, future values, fund segment, etc. In an operation 102, financial reports are prepared using the financial data received in addition to other data associated with annuity accounts.

In an operation 103, an annuity account is selected for processing. In an operation 104, a determination is made concerning whether or not the account is a new account. If the account is determined not to be a new account, processing continues in an operation 114. If the account is determined to be a new account, data for the new account is defined in an operation 106. For example, a check and an application is received into a document control unit, a policy number is assigned to the new account, account holder information is defined, the money paid by the account holder is applied to the premium, etc. The application may be prepared electronically or scanned and indexed from a hardcopy application. A check may be scanned and indexed. Alternate payment methods also may be applied to the new account including a wire transfer, a receipt of cash, a debit/credit card payments, etc. The application may be reviewed for accuracy and completeness using automated methods as known to those skilled in the art or manually. In an operation 110, the data associated with the new account is stored in a database. Use of the term database is not meant to infer a structure on the data stored, but may be any mechanism for storing the data in any type of memory for access by a computer program. The database may be divided into a plurality of databases. In an operation 112, a deposit for each fund in the new account is determined. New account deposits may occur when opened or at any other scheduled time. For example, all new accounts may issue at a predetermined time such as the Friday following the account opening. The customer service representative may apply the initial premium and enter the account into a suspense state using a particular transaction code and setting the current date as the effective date. An auto-suspense function may be activated automatically, and a transaction code may be generated that applies the premium to the policy.

In an operation 114, a determination is made concerning whether or not the current date is an account anniversary. If the current date is determined not to be an account anniversary, processing continues in an operation 118. If the current date is determined to be an account anniversary, account changes are determined according to fund and segment in an operation 116. In an operation 118, an account value by fund and segment is determined. In an operation 120, account values are reconciled to a valuation fund table based on the policy and the fund. In an operation 122, a determination is made whether or not there is another account to process. If there is another account to process, processing continues at operation 104. If there is not another account to process, processing continues at operation 124.

In an operation 124, the account values for all accounts, including new accounts, is compiled into a summary file. In an exemplary embodiment, the summary file is prepared daily, although other time periods may be used. Additionally, the summary file may include data such as a liability extract for the annuity accounts, a gross bond equivalent yield, an option trade ticket, a fixed asset extracts file, etc. The data may be updated on a periodic basis that may vary based on the data type. For example, the gross bond equivalent yield may be received weekly; whereas, the option trade ticket may be received monthly. The gross bond equivalent yield is the yield available on investments used to back the annuity account core of investments and may be developed with the assistance of portfolio managers based on current market conditions. The gross bond equivalent yield is used to determine an option budget. The data may be received electronically for example using the file transfer protocol (FTP), e-mail, facsimile, etc. In an operation 126, the prepared summary file is sent to a hedge model to evaluate the position of the funds allocated to accounts. In an exemplary embodiment, the hedge model is MG-HEDGE® a system for providing risk analysis and hedging of market exposures. In an exemplary embodiment, the summary file is send automatically on a periodic basis. For example, the summary file may be sent weekly. In an operation 128, a hedge report is received from the hedge model. The hedge report is received electronically, for example through email, though other electronic means such as FTP, facsimile, etc. are contemplated. The hedge report may include a summary of annuity liabilities to be hedged, a risk position report, a cash flow projection report, an option budget history report, etc.

In an operation 130, account data including the hedge report are analyzed. In an operation 132, a breakthrough level and a breakthrough rate are determined for each annuity based on market information including bond yields, a risk-free yield curve, an implied dividend yield; an implied volatility, the hedge report, etc. The determined breakthrough level and breakthrough rate are stored in a database in an operation 134. The determined breakthrough level and breakthrough rate may be reviewed before being approved and stored in the database. In an operation 136, the liabilities to hedge are identified based on the market information, the hedge report, etc. In an operation 138, trades are executed as required based on the identified liabilities to hedge. The trades may be executed electronically and may be to buy or to sell.

It should be appreciated, of course, that the details associated with the annuity described herein merely represent one possible implementation. The invention is described herein with reference to drawings. These drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing it operations. The embodiments of the present invention may be implemented using an existing computer processor, or by a special purpose computer processor incorporated for this or another purpose or by a hardwired system.

Embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which ca be used to carry or stored desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods described herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links or by a combination of hardwired and wireless links) through a communications network. In a distributed computing environment, program modules may be located in both local and remote memory storage devices.

It should be noted that although the flow charts provided herein show a specific order of method operations or steps, it is understood that the order of these operations or steps may differ from what is depicted. Also two or more operations or steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention in various embodiments and with various modifications as are suited to the particular use contemplated.

While several embodiments of the invention have been described, it is to be understood that modification and changes will occur to those skill in the art to which the invention pertains. Accordingly, the claims dependent to this specification are intended to define the invention more precisely.

1. A computer implemented method of assessing an interest increase in an annuity linked to an index of equities, the method comprising:
determining a change in an equity index over a time period;
setting an interest increase in an annuity to a floor if the determined change in the equity index is not greater than the floor;
calculating the interest increase in the annuity to be a participation percentage of the determined change in the equity index if the determined change is greater than the floor, wherein the participation percentage of the determined change is calculated up to a threshold change level in the determined change in the equity index; and
adding an enhanced interest increase amount to the interest increase in the annuity if the determined change in the equity index is greater than the threshold change level, wherein the enhanced interest increase amount is an enhanced percentage of the determined change in the equity index above the threshold change level.

2. The computer implemented method of claim 1, wherein the enhanced percentage is 100 percent.

3. The computer implemented method of claim 1, wherein the time period is one annuity contract year.

4. The computer implemented computer implemented method of claim 1, wherein the time period is a term of the annuity.

5. The computer implemented method of claim 1, wherein determining the change in the equity index comprises determining a high point in the equity index over the time period and determining the change by subtracting the high point by a value of the equity index at a beginning of the time period, wherein the time period is a contract year for the annuity.

6. The computer implemented method of claim 1, further comprising calculating a new value of the annuity by adding the interest increase in the annuity to the annuity.

7. The computer implemented method of claim 1, wherein the floor is a guaranteed minimum interest rate.

8. A fixed index annuity product embodied in a memory of a computer comprising:
an index term, wherein the index term is a period over which index-linked interest of an equity index is calculated;
a participation rate, wherein the participation rate is a percentage of an index increase of the equity index over the index term used in determining the index-linked interest up to a threshold index increase level; and
an enhanced rate, wherein the enhanced rate is a rate of the index increase of the equity index over the index term used in determining the index-linked interest over the threshold index increase level.

9. The product of claim 8, wherein the index term is one year.

10. The product of claim 8, wherein the enhanced rate is 100 percent.

11. The product of claim 8, wherein the equity index is Standard & Poor's 500 (S&P 500).

12. The product of claim 8, wherein the equity index is a NASDAQ index.

13. The product of claim 8, wherein the participation rate is 25%.

14. The product of claim 8, further comprising an annuity value, wherein the annuity value increases by the index-linked interest at each index term.

15. A system for calculating index-linked interest in a fixed index annuity having a breakthrough level above which an enhanced percentage of index gain is provided to the index-linked interest, the system comprising:
means for determining gain in an equity index; and
means for determining index-linked interest for an equity index annuity that tracks the equity index, wherein the index-linked interest is a percentage of the determined gain up to a threshold plus an enhanced percentage of the determined gain above the threshold.

16. The system of claim 15, wherein the gain in the equity index is determined over a one year period.

17. The system of claim 15, wherein the gain in the equity index is determined over entire term of the annuity.

18. The system of claim 15, wherein the enhanced percentage is 100%.

19. The system of claim 15, wherein the enhanced percentage is a multiple of the percentage used to calculate the index-linked interest of the determined gain up to the threshold.

20. The system of claim 15, wherein the index-linked interest is a percentage of the determined gain up to a first threshold plus a first enhanced percentage of the determined gain up to a second threshold plus a second enhanced percentage of the determined gain above the second threshold.
